(19) United States
(12) Patent Application Publication
(10) Pub. No.: US 2024/0010854 A1
(43) Pub. Date: Jan. 11, 2024

(54) COMPOSITION FOR COATING A CARBON NANOMATERIAL

(71) Applicant: CARBON T&C Co. Ltd., Seoul (KR)

(72) Inventors: Gun Soo KIM, Seoul (KR); Young Bin CHOI, Seoul (KR)

(73) Assignee: CARBON T&C Co. Ltd., Seoul (KR)

(21) Appl. No.: 18/344,621

(22) Filed: Jun. 29, 2023

(30) Foreign Application Priority Data
Jul. 11, 2022 (KR) 10-2022-0085069

(51) Int. Cl. C09D 7/63; C09D 7/20; C09D 7/65; H01M 4/133; H01M 4/1391

(52) U.S. Cl. CPC C09D 7/63; C09D 7/20; C09D 7/65; H01M 4/133; H01M 4/1391

(57) ABSTRACT

The present invention relates to a composition for coating a carbon nanomaterial, comprising a bipolar compound, an amine-based dispersant, and a solvent. Unlike conventional coating solutions using an ionic dispersant, the composition for coating a carbon nanomaterial of the present invention is used together with a polymer-based dispersant to reduce the cost incurred during the coating, and the coating is completed within minutes, thereby reducing the coating time. In addition, unlike the conventional coating solutions that require drying at a temperature of 150° C. or higher, the coating composition of the present invention can be dried at a low temperature, which can save time and cost required for coating.

### CROSS REFERENCE TO RELATED APPLICATION

The present application claims priority to Korean Patent Application No. 10-2022-0085069, filed Jul. 11, 2022, the entire contents of which is incorporated herein for all purposes by this reference.

### TECHNICAL FIELD

The present invention relates to a composition for coating a carbon nanomaterial, comprising a bipolar compound, a polyvinyl dispersant, and a solvent.

### BACKGROUND ART

Recently, there has been growing interest in energy storage technology, and starting with commercialization of carbon materials in leisure products, the scope of utilization of carbon materials is being gradually expanded, such as, to automobiles, aviation, IT, and new renewable energy.

Nanocarbon materials are carbon-based nanomaterials, which refer to carbon quantum dots or fullerenes having 0-dimensional carbon structures, carbon nanoribbons and carbon nanotubes having 1-dimensional carbon structures, and graphene having 2-dimensional carbon structures. When nanocarbon materials are classified according to the state of the material, they may be largely divided into carbon quantum dots, fullerenes, carbon nanoribbons, carbon nanotubes, and graphene, which may be divided into top-down and bottom-up methods according to the manufacturing methods of each material.

Nanocarbon materials have the characteristics of carbon materials with high strength and high thermal conductivity. In particular, when the size of the material is very small, such as that of carbon quantum dots, phenomena of quantum physics (various characteristics comprising light emission, band gap changes, down-conversion by energy transition, etc.) may be found. Since such nanocarbon materials have excellent electrical, physical, chemical, and mechanical properties, they are emerging as new materials that may be used to overcome the technological limitations of existing industries.

As existing parts and materials are gradually being replaced by carbon materials, private companies are also actively studying ways to increase interest in carbon materials and to commercialize them in order to improve their competitiveness. Accordingly, nanocarbon materials have emerged as conductive materials for electromagnetic shielding and coating materials for touch panels, and use of such materials is increasing rapidly, replacing existing electrically conductive polymer composite materials.

The unique physical properties of carbon nanotubes (CNT) have the potential to influence innovation in multiple application fields, and various product innovations using CNT may be expected to appear in such fields in the future. Due to the characteristics of carbon fiber having lightweight and high-strength, there is an increasing demand for CNT in the field of civil engineering such as building materials, concrete structures, and earthquake-resistant reinforcement, and in the alternative energy fields such as compressed natural gas storage (CNG) tanks, blades for wind power generation, centrifugal rotors, and flywheels.

Graphene, another nanocarbon material having unique properties just like CNT, is also expected to influence innovation in various application fields. While CNT has a linear structure, graphene has a plate structure, and the demand is increasing in various fields as in the case of CNT.

With the recent development of 5G and 6G, there is a growing demand to improve the heat dissipation characteristics of alumina or boron powder used for heat dissipation materials, and the heat dissipation of LED used in automobiles is also an issue.

When manufacturing multilayer ceramic capacitors, inductors, and chip resistors, which are representative chip components, ceramic powder and numerous additives are added, and manufacturing the chip components having high capacity and miniaturized size is in progress by improving the performance of such additives.

### PRIOR ART CITATION

Korean Patent No. 1321097

### SUMMARY OF INVENTION

### Technical Problem

The present invention is to provide a composition for coating a carbon nanomaterial, comprising a bipolar compound, a polyvinyl dispersant, and a solvent.

According to an embodiment of the present invention, the present invention provides a method for coating a carbon nanomaterial, comprising the steps of: (1) mixing the carbon nanomaterial dispersion comprising a carbon nanomaterial, a polyvinyl dispersant, a polyamine dispersant and a solvent, with a material to be coated, to adsorb the carbon nanomaterial on the surface of the material to be coated; (2) adding a composition for coating a carbon nanomaterial of any one of claims 1 to 12 to coat the carbon nanomaterial on the surface of the material to be coated; and (3) drying the material to be coated.

### Solution to Problem

The present invention provides a composition for coating a carbon nanomaterial, comprising a bipolar compound, a polyvinyl dispersant, and a solvent.

The bipolar compound may be selected from the group consisting of caffeine, adenosine, alanine, arginine, histidine, ethanolamine, urea, amino sulfate, and MBA (N—N′Methylbibrate), but the present invention is not limited thereto.

The polyvinyl dispersant may be a polymer comprising pyrrolidone, but the present invention is not limited thereto.

The polyvinyl dispersant may be Poly(4VP-co-NVP) or PEG (Poly Ethylene Glycol)-PVP (PolyVinylPyrrolidone) copolymer, but the present invention is not limited thereto.

The Poly(4VP-co-NVP) may be polymerized by 4-vinylpyridine and N-vinylpyrrolidone, but the present invention is not limited thereto.

The solvent may be any one selected from the group consisting of H₂O, ethanol, N-methylpyrrolidone (NMP), DMF, DMSO, and acetone, but the present invention is not limited thereto.

The composition for coating a carbon nanomaterial may be used together with a carbon nanomaterial dispersion comprising a carbon nanomaterial, a polyacrylic dispersant, a polyvinyl dispersant, and a solvent, but the present invention is not limited thereto.

The carbon nanomaterial may be selected from the group consisting of carbon nanotube (CNT), carbon fiber, graphene, carbon black, and mixtures thereof, but the present invention is not limited thereto.

The polyacrylic dispersant may be selected from the group consisting of polyacrylonitrile, polyacrylic acid, polyvinylpyrrolidone, polymethacrylate, polymethyl methacrylate (PMMA), polyethyl methacrylate (PEMA), Poly-HEMA (poly-2-hydroxyethyl methacrylate), and mixtures thereof, but the present invention is not limited thereto.

The carbon nanomaterial dispersion further comprises a polyethylene-based dispersant, and such polyethylene-based dispersant may be selected from the group consisting of sodium dodecyl sulfate (SDS), sodium lauryl sulfate (SLS), sodium dodecyl phosphate (SDP), polyvinyl chloride (PVC), poly(vinylidene dichloride) (PVDC), polyglycolide (PGA), polyethylene glycol (PEG), polyethylene oxide (PEO), and mixtures thereof, but the present invention is not limited thereto.

The polyvinyl dispersant may be the same as the polyvinyl dispersant of claim. 1, but the present invention is not limited thereto.

The solvent may be selected from the group consisting of H₂O, ethanol, N-methylpyrrolidone (NMP), DMF, DMSO, and acetone, but the present invention is not limited thereto.

According to another embodiment of the present invention, the present invention provides a method for coating a carbon nanomaterial, the steps of: (1) mixing the carbon nanomaterial dispersion comprising a carbon nanomaterial, a polyvinyl dispersant, a polyamine dispersant and a solvent, with a material to be coated, to adsorb the carbon nanomaterial on the surface of the material to be coated; (2) adding a composition for coating a carbon nanomaterial of any one of claims 1 to 12 to coat the carbon nanomaterial on the surface of the material to be coated; and (3) drying the material to be coated.

The material to be coated may be any one of a lithium battery cathode material, SiOx, SiNx, SiOxNy, AlOx, zinc oxide (ZnO), and silicon carbide (SiC), but the present invention is not limited thereto.

The lithium battery cathode material may be at least one selected from the group consisting of LTO (Li₁₄Ti₁₅O₁₂). LCO (LiCoO₂), NCM (Li[Ni,Co,Mn]O₂), NCMA (Li[Ni·Co·Mn·Al]O₂), NCA (Li[Ni,Co,Al]O₂), LMO (LiMn₂O₄), LFP (LiFePO₄), and LCP (LiCoPO₄), but the present invention is not limited thereto.

### Advantageous Effects of Invention

Unlike conventional coating solutions using an ionic dispersant, the composition for coating a carbon nanomaterial of the present invention is used together with a polymer-based dispersant to reduce the cost incurred during the coating, and the coating is completed within minutes, thereby reducing the coating time. In addition, unlike the conventional coating solutions that require drying at a temperature of 150° C. or higher, the coating composition of the present invention can be dried at a low temperature, which can save time and cost required for coating.

### BRIEF DESCRIPTION OF DRAWINGS

FIG. 1 is a SEM image for identifying the carbon nanotube coated on the surface of a polycrystalline (NCM) by using the carbon nanomaterial coating composition of the present invention.

FIG. 2 is a SEM image for identifying the carbon nanotube coated on the surface of a single crystal (NCM) by using the carbon nanomaterial coating composition of the present invention.

FIG. 3 is a SEM image for identifying the carbon nanotube coated on the surface of LFP by using the carbon nanomaterial coating composition of the present invention.

FIG. 4 is a SEM image for identifying the carbon nanotube coated on the surface of SiOx by using the carbon nanomaterial coating composition of the present invention.

FIG. 5 is a SEM image for identifying the carbon nanotube coated on the surface of SiC by using the carbon nanomaterial coating composition of the present invention.

FIG. 6 is a SEM image for confirming the carbon nanotubes coated on the surface of SiC by using the carbon nanomaterial coating composition of the present invention.

### MODE FOR INVENTION

In the entire specification of the present invention, the description that a certain part “comprises” a certain component means that the part may further comprise other components, rather than excluding other components, unless described otherwise.

In the entire specification of the present invention, the description that a certain step is located “on” or “before” another step means that the step may have the same right as the case that the step is either in a direct time-series relationship with another step and or in an indirect time-series relationship in which the order of the two steps may be changed, such as a mixing step after each step.

The terms “about,” “substantially,” and the like, as used throughout the specification of the present invention, are used for the value or an approximating value when manufacturing and material tolerances inherent in the stated meaning are presented. Such terms are also used to prevent unscrupulous infringers from unfairly using the described features with accurate or absolute figures mentioned to help understand the present invention. The term “a step of (doing)” or “a step of” used throughout the present specification does not mean “a step for.”

The present invention provides a composition for coating a carbon nanomaterial, comprising a bipolar compound, a polyvinyl dispersant, and a solvent. Such composition for coating a carbon nanomaterial may comprise 96 to 99% by weight of a solvent, 0.1 to 1% by weight of a bipolar compound, and to 3% by weight of a polyvinyl dispersant.

The composition for coating a carbon nanomaterial may be used together with a carbon nanomaterial dispersion comprising a carbon nanomaterial, a polyacrylic dispersant, a polyvinyl dispersant, and a solvent, but the present invention is not limited thereto.

The carbon nanomaterial dispersion may comprise 93 to 98% by weight of a solvent, 0.1 to 2% by weight of a carbon nanomaterial, 0.1 to 3% by weight of a polyacrylic dispersant, and 0.1 to 2% by weight of a polyvinyl dispersant.

The carbon nanomaterial dispersion may further comprise a polyethylene-based dispersant. The polyethylene-based dispersing agent may be added to improve the dispersing effect. Although a polymer dispersant is effective as a main dispersant, the dispersion force may slightly decrease due to the binding force between polymers. Therefore, the dispersion effect may be improved by adding a polyethylene-based dispersing agent as a partial dispersing agent.

According to another embodiment of the present invention, the present invention provides a method for coating a carbon nanomaterial, comprising the steps of: (1) mixing the carbon nanomaterial dispersion comprising a carbon nanomaterial, a polyvinyl dispersant, a polyamine dispersant and a solvent, with a material to be coated, to adsorb the carbon nanomaterial on the surface of the material to be coated; (2) adding a composition for coating a carbon nanomaterial of any one of claims 1 to 12 to coat the carbon nanomaterial on the surface of the material to be coated; and (3) drying the material to be coated.

In step (1), 100 to 300 parts by weight of the material to be coated may be mixed with respect to 100 parts by weight of the carbon nanomaterial dispersion, but the present invention is not limited thereto.

In step (2), 50 to 200 parts by weight of the composition for coating a carbon nanomaterial may be mixed with respect to 100 parts by weight of the carbon nanomaterial dispersion, but the present invention is not limited thereto.

The temperature of the drying step may be 50-100° C., but the present invention is not limited thereto.

### Example 1

1. Preparation of a Carbon Nanotube Dispersion

2 g of polyacrylic acid and 1 g of polyvinyl dispersant Poly(4VP-co-NVP) were added to 96 g of solvent N-methylpyrrolidone and stirred, and 1 g of carbon nanotubes was added thereto and dispersed to prepare a final carbon nanotube dispersion.

2. Preparation of a Carbon Nanomaterial Coating Solution

0.6 g of an ethanolamine (EDA) having both charges and 1 g of polyvinyl dispersant Poly (4VP-co-NVP) were added to 98.4 g of solvent N-methylpyrrolidone and stirred to prepare a carbon nanomaterial coating solution.

3. Carbon Nanotube Coating Using a Dispersion and a Coating Solution

200 g of NCM to be coated was added to 100 g of the prepared carbon nanotube dispersion and mixed so that the carbon nanotubes were adsorbed on the surface of NCM, and then 100 g of the carbon nanomaterial coating solution was added to coat the adsorbed carbon nanotubes on the surface of NCM.

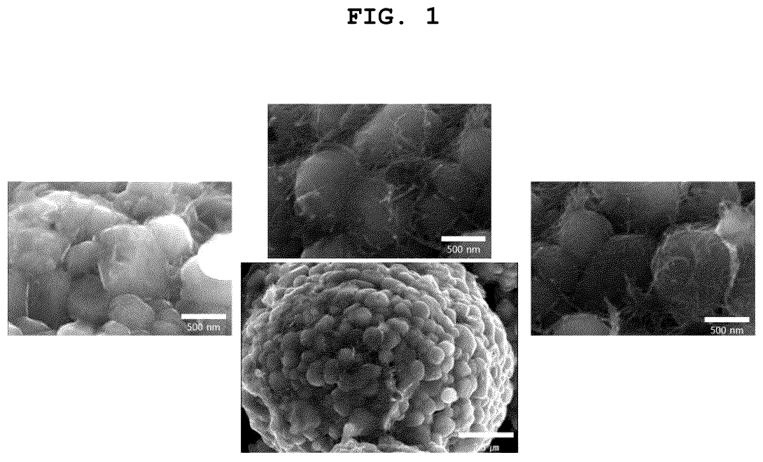

After trying the surface of the NCM coated with the carbon nanotubes at the temperature of 80° C., and observing by using a SEM microscope, it was confirmed that the carbon nanotubes were coated on the surface of the NCM (FIG. 1).

### Example 2

1. Preparation of a Carbon Nanotube Dispersion

2 g of polyvinylpyrrolidone and 1 g of polyvinyl dispersant PEG-PVP were added to 96 g of solvent water and stirred, and 1 g of carbon nanotubes were added and dispersed to prepare a final carbon nanotube dispersion.

2. Preparation of a Carbon Nanomaterial Coating Solution

0.6 g of caffeine having both charges and 1 g of polyvinyl dispersant PEG-PVP were added to 98.4 g of solvent water and stirred to prepare a carbon nanomaterial coating solution.

3. Carbon Nanotube Coating Using a Dispersion and a Coating Solution

200 g of NCM to be coated was added to 100 g of the prepared carbon nanotube dispersion and mixed so that the carbon nanotubes were adsorbed on the surface of NCM, and then 100 g of the carbon nanomaterial coating solution was added to coat the adsorbed carbon nanotubes on the surface of NCM.

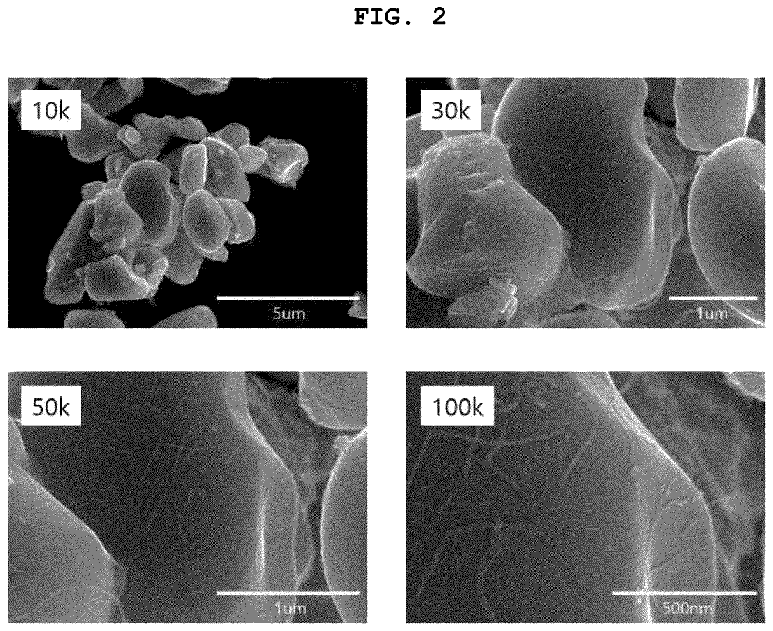

After drying the surface of the NCM coated with the carbon nanotubes at the temperature of 80° C., and observing by using a SEM microscope, it was confirmed that the carbon nanotubes were coated on the surface of the NCM (FIG. 2).

### Example 3

1. Preparation of a Carbon Nanotube Dispersion

2 g of polyvinyl alcohol and 1 g of polyvinyl dispersant Poly (4VP-co-NVP) was added to 96 g of solvent N-methylpyrrolidone and stirred, and 1 g of carbon nanotubes were added and dispersed to prepare a final carbon nanotube dispersion.

2. Preparation of a Carbon Nanomaterial Coating Solution

0.6 g of ethanolamine (EDA) having both charges and 1 g of polyvinyl dispersant Poly(4VP-co-NVP) were added to 98.4 g of solvent N-methylpyrrolidone, and stirred to prepare a carbon nanomaterial coating solution.

3. Carbon Nanotube Coating Using a Dispersion and a Coating Solution

200 g of NCM to be coated were added to 100 g of the prepared carbon nanotube dispersion and mixed so that the carbon nanotubes were adsorbed on the surface of the LFP, and then 100 g of the carbon nanomaterial coating solution was added to coat the adsorbed carbon nanotubes on the surface of the LFP.

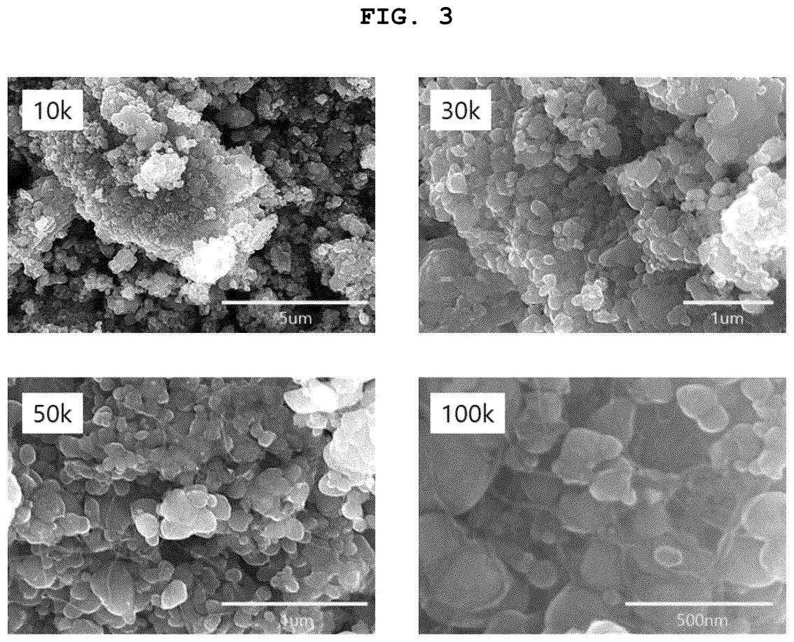

After drying the surface of the LFP coated with the carbon nanotubes at the temperature of 80° C., and observing by using a SEM microscope, it was confirmed that the carbon nanotubes were coated on the surface of the LFP (FIG. 3).

### Example 4

1. Preparation of a Carbon Nanotube Dispersion

2 g of polyacrylonitrile and 1 g of polyvinyl dispersant Poly(4VP-co-NVP) were added to 96 g of solvent N-methylpyrrolidone and stirred, and 1 g of carbon nanotubes were added and dispersed to prepare a final carbon nanotube dispersion.

2. Preparation of a Carbon Nanomaterial Coating Solution

0.6 g of adenosine having both charges and 1 g of polyvinyl dispersant Poly(4VP-co-NVP) were added to 98.4 g of solvent N-methylpyrrolidone and stirred to prepare a carbon nanomaterial coating solution.

3. Carbon Nanotube Coating Using a Dispersion and a Coating Solution

200 g of SiOx to be coated were added to 100 g of the prepared carbon nanotube dispersion and mixed so that the carbon nanotubes were adsorbed to the surface of SiOx, and then 100 g of the carbon nanomaterial coating solution was added to coat the adsorbed carbon nanotubes on the surface of SiOx.

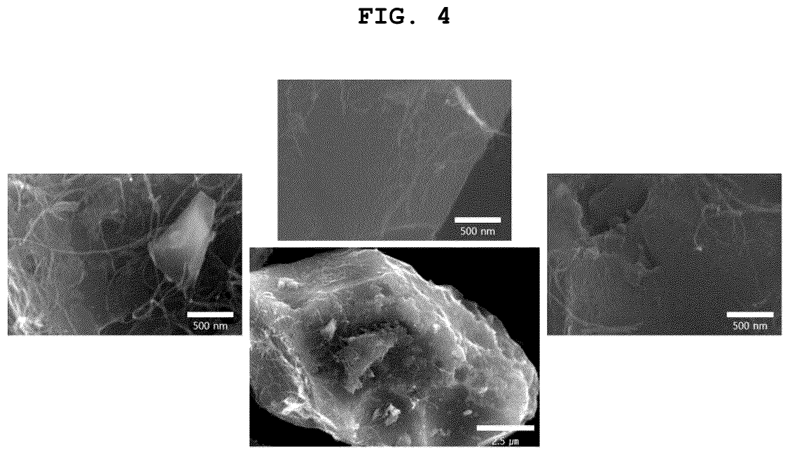

After drying the surface of SiOx coated with the carbon nanotubes at the temperature of 80° C., and observing by using a SEM microscope, it was confirmed that the carbon nanotubes were coated on the surface of SiOx (FIG. 4).

### Example 5

1. Preparation of a Carbon Nanotube Dispersion

2 g of polyvinylpyrrolidone and 1 g of polyvinyl dispersant Poly(4VP-co-NVP) were added to 96 g of solvent N-methylpyrrolidone and stirred, and 1 g of carbon nanotubes were added and dispersed to prepare a final carbon nanotube dispersion.

2. Preparation of a Carbon Nanomaterial Coating Solution

0.6 g of ethanolamine (EDA) having both charges and 1 g of a polyvinyl dispersant Poly(4VP-co-NVP) were added to 98.4 g of solvent N-methylpyrrolidone and stirred to prepare a carbon nanomaterial coating solution.

3. Carbon Nanotube Coating Using a Dispersion and a Coating Solution

200 g of SiC to be coated were added to 100 g of the prepared carbon nanotube dispersion and mixed so that the carbon nanotubes were adsorbed on the surface of SiC, and then 100 g of the carbon nanomaterial coating solution were added to coat the adsorbed carbon nanotubes on the surface of SiC.

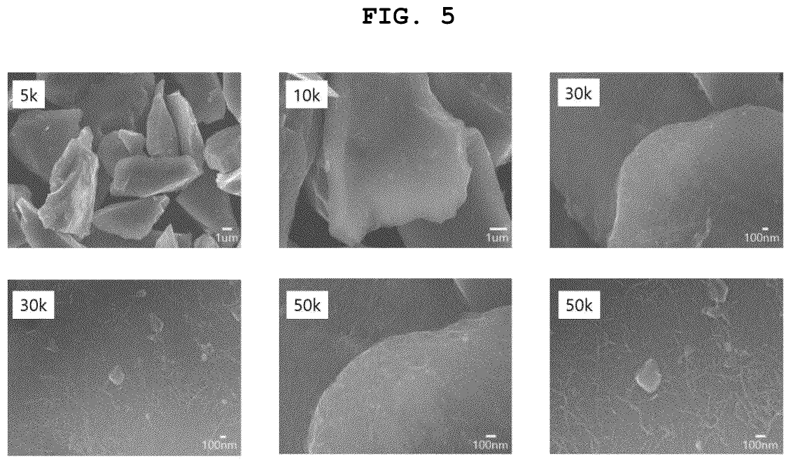

After drying the surface of SiC coated with the carbon nanotubes at the temperature of 80° C., and observing by using a SEM microscope, it was confirmed that that the carbon nanotubes were coated on the surface of SiC (FIG. 5).

### Example 6

1. Preparation of a Graphene Dispersion

2 g of polyvinylpyrrolidone and 1 g of polyvinyl dispersant Poly(4VP-co-NVP) were added to 96 g of solvent N-methylpyrrolidone and stirred, and 1 g of graphene was added and dispersed to prepare a final graphene dispersion.

2. Preparation of a Carbon Nanomaterial Coating Solution

0.6 g of ethanolamine (EDA) having both charges and 1 g of a polyvinyl dispersant Poly (4VP-co-NVP) were added to 98.4 g of solvent N-methylpyrrolidone and stirred to prepare a carbon nanomaterial coating solution.

3. Graphene Coating Using a Dispersion and a Coating Solution

200 g of SiC to be coated was added to 100 g of the prepared graphene dispersion and mixed so that graphene was adsorbed on the surface of SiC, and then 100 g of the carbon nanomaterial coating solution was added to coat the adsorbed graphene on the surface of SiC.

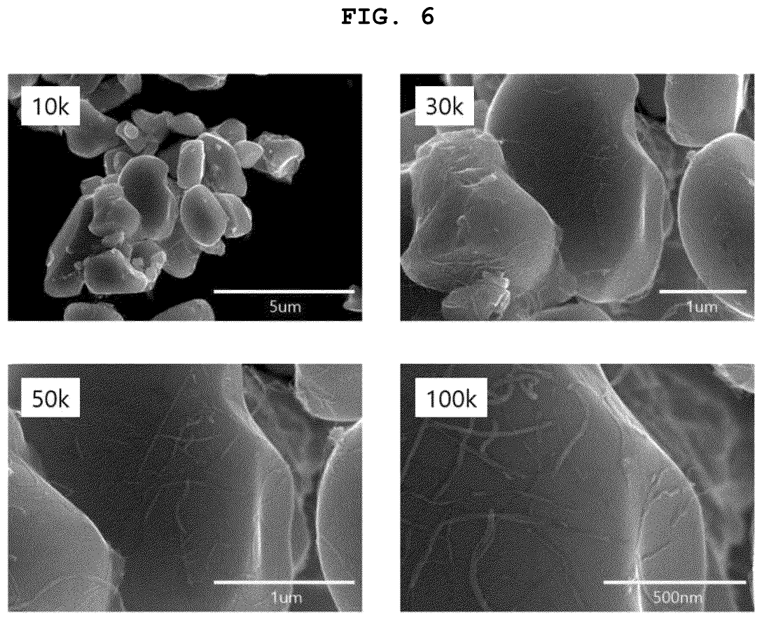

After drying the surface of SiC coated with graphene at the temperature of 80° C., and observing by using a SEM microscope, it was confirmed that that the graphene was coated on the surface of SiC (FIG. 6).

### EXPERIMENTAL EXAMPLES

1. Measurement of Electrochemical Properties

The electrical resistance of NCM523 was measured and compared with that of NCM523 coated with CNT, as follows.

In Experimental Example (1), Bare NCM523 not coated with CNT:Super-P:PVdF were mixed in a ratio of 98:1:1 and coated on an aluminum current collector.

In Experimental Example (2), Bare NCM523 not coated with CNT:CNT:PVdF were mixed in a ratio of 98:1:1 and coated on an aluminum current collector.

In Experimental Example (3), Bare NCM523 not coated with CNT:CNT:Super-P, PVdF were mixed in a ratio of 97.5:0.5:1:1 and coated on an aluminum current collector.

In Experimental Example (4), NCM523 coated with 0.5% CNT:Super-P:PVdF were mixed in a ratio of 97.5 (+0.5% CNT):1:1 and coated on an aluminum current collector. At this time, wt % PVP based on the total weight of the carbon nanomaterial dispersion was used as a dispersant for the CNT coating.

In Experimental Example (5), NCM523 coated with 0.5% CNT:Super-P:PVdF were mixed in a ratio of 97.5 (+0.5% CNT):1:1 and coated on an aluminum current collector. At this time, wt % PVP based on the total weight of the carbon nanomaterial dispersion was used as a dispersant for the CNT coating.

In Experimental Example (6), NCM523 coated with 0.5% CNT:Super-P:PVdF were mixed in a ratio of 97.5 (+0.5% CNT):1:1 and coated on an aluminum current collector. At this time, 1.0 wt % PVP based on the total weight of the carbon nanomaterial dispersion was used as a dispersant for the CNT coating.

The mixtures coated on the aluminum current collector in Experimental Examples 1 to 6 were vacuum dried (at 100° C. for 6 hours) and measured by using a surface measuring instrument (ST-4).

TABLE 1

| | Before | After |
|---|---|---|
| | Press | Press |
| (1) Bare NCM523:Super-P:PVdF = | 10\hat{ }3.7 | 10\hat{ }3.4 |
| 98:1:1 | | |
| (2) Bare NCM523:CNT:PVdF = | 10\hat{ }3.1 | 10\hat{ }3.0 |
| 98:1:1 | | |
| (3) Bare NCM523:CNT:Super- | 10\hat{ }3.4 | 10\hat{ }3.1 |
| P:PVdF = 97.5:0.5:1:1 | | |
| (4) 0.5% CNT coated | 10\hat{ }3.0 | 10\hat{ }2.8 |
| NCM523:Super-P:PVdF = | | |
| 97.5 (+CNT 0.5%):1:1 | | |
| (0.1% PVP used for CNT coating) | | |
| (5) 0.5% CNT coated | 10\hat{ }3.3 | 10\hat{ }3.0 |
| NCM523:Super-P:PVdF = | | |
| 97.5 (+CNT 0.5%):1:1 | | |
| (0.5% PVP used for CNT coating) | | |
| (6) 0.5% CNT coated | 10\hat{ }3.0 | 10\hat{ }3.5 |
| NCM523:Super-P:PVdF = | | |
| 97.5 (+CNT 0.5%):1:1 | | |
| (1.0% PVP used for CNT coating) | | |

Experimental Examples (1) and (2) are data obtained by measuring and comparing the sheet resistances of Super-P and CNT, which are conductive materials, and show that CNT has excellent conductivity, as compared to Super-P.

Experimental examples (3) and (4) show the sheet resistance of bare NCM and CNT-coated NCM. When comparing the case of separately using CNT as a conductive material with the case of pre-coating CNT on NCM, NCM pre-coated with CNT is advantageous in terms of CNT dispersion and, thus, shows low sheet resistance.

Experimental Examples (4), (5), and (6) show that the sheet resistance increases as the content of the binder used for coating the CNT increases.

The above-described data shows that CNT is superior to Super-P as a conductive material, and, when CNT is pre-coated on NCM, the dispersion of CNT is better, resulting in low sheet resistance.

Having described specific parts of the present invention in detail above, it is clear to those skilled in the art that such specific descriptions are only preferred embodiments, and the scope of the present invention is not limited thereto. Accordingly, the substantial scope of the present invention will be defined by the attached claims and the equivalents thereto.

1. A composition for coating a carbon nanomaterial, comprising a bipolar compound, a polyvinyl dispersant, and a solvent.

2. The composition for coating a carbon nanomaterial according to claim 1, characterized in that the bipolar compound is any one selected from the group consisting of caffeine, adenosine, alanine, arginine, histidine, ethanolamine, urea, amino sulfate and MBA (N-N′-Methylenebisacrylamide).

3. The composition for coating a carbon nanomaterial according to claim 1, characterized in that the polyvinyl dispersant is a polymer comprising pyrrolidone.

4. The composition for coating a carbon nanomaterial according to claim 1, characterized in that the polyvinyl dispersant is Poly(4VP-co-NVP) or PEG (Poly Ethylene Glycol)-PVP (PolyVinylPyrrolidone) copolymer.

5. The composition for coating a carbon nanomaterial according to claim 4, characterized in that the Poly(4VP-co-NVP) is polymerized by 4-vinylpyridine and N-vinylpyrrolidone.

6. The composition for coating a carbon nanomaterial according to claim 1, characterized in that the solvent is any one selected from the group consisting of H₂O, ethanol, N-methylpyrrolidone (NMP), DMF, DMSO and acetone.

7. The composition for coating a carbon nanomaterial according to claim 1, characterized in that it is used together with a carbon nanomaterial dispersion comprising a carbon nanomaterial, a polyacrylic dispersant, a polyvinyl dispersant, and a solvent.

8. The composition for coating a carbon nanomaterial according to claim 7, characterized in that the carbon nanomaterial is selected from the group consisting of carbon nanotube (CNT), carbon fiber, graphene, carbon black, and a mixture thereof.

9. The composition for coating a carbon nanomaterial according to claim 7, characterized in that the polyacrylic dispersant is selected from the group consisting of polyacrylonitrile, polyacrylic acid, polyvinylpyrrolidone, polymethacrylate, polymethyl methacrylate (PMMA), polyethyl methacrylate (PEMA), Poly-HEMA (Poly-HEMA)-2-hydroxyethyl methacrylate) and a mixture thereof.

10. The composition for coating a carbon nanomaterial according to claim 7, characterized in that the carbon nanomaterial dispersion further comprises a polyethylene-based dispersant, wherein the polyethylene-based dispersant is selected from the group consisting of sodium dodecyl sulfate (SDS), sodium lauryl sulfate (SLS), sodium dodecyl phosphate (SDP), polyvinyl chloride (PVC), poly(vinylidene dichloride) (PVDC), polyglycolide (PGA), polyethylene glycol (PEG), polyethylene oxide (PEO), and mixtures thereof.

11. The composition for coating a carbon nanomaterial according to claim 7, characterized in that the polyvinyl dispersant is the same as the polyvinyl dispersant of claim 1.

12. The composition for coating a carbon nanomaterial according to claim 7, characterized in that the solvent is any one selected from the group consisting of H₂O, ethanol, N-methylpyrrolidone (NMP), DMF, DMSO and acetone.

13. A method for coating a carbon nanomaterial, comprising the steps of:
(1) mixing the carbon nanomaterial dispersion comprising a carbon nanomaterial, a polyvinyl dispersant, a polyamine dispersant and a solvent, with a material to be coated, to adsorb the carbon nanomaterial on the surface of the material to be coated;
(2) adding a composition for coating a carbon nanomaterial of claim 1 to coat the carbon nanomaterial on the surface of the material to be coated; and
(3) drying the material to be coated.

14. The method for coating a carbon nanomaterial according to claim 13, characterized in that the material to be coated is any one of lithium battery cathode material, SiOx, SiNx, SiOxNy, AlOx, zinc oxide (ZnO), and silicon carbide (SiC).

15. The method for coating a carbon nanomaterial according to claim 14, characterized in that the lithium battery cathode material comprises at least any one selected from the group consisting of LTO (Li₁₄Ti₁₅O₁₂), LCO (LiCoO₂), NCM (Li[Ni,Co,Mn]O₂), NCMA (Li[Ni·Co·Mn·Al]O₂), NCA (Li[Ni,Co,Al]O₂), LMO (LiMn₂O₄), LFP (LiFePO₄), and LCP (LiCoPO₄).
